(19) United States
(12) Patent Application Publication
(10) Pub. No.: US 2014/0229320 A1
(43) Pub. Date: Aug. 14, 2014

(54) CONGESTION FREE SHOPPING

(71) Applicant: INTERNATIONAL BUSINESS MACHINES CORPORATION, Armonk, NY (US)

(72) Inventors: Siddique A. Mohammed, Bangalore (IN); Robyn R. Schwartz, Chicago, IL (US); Dhandapani Shanmugam, Bangalore (IN)

(73) Assignee: INTERNATIONAL BUSINESS MACHINES CORPORATION, Armonk, NY (US)

(21) Appl. No.: 13/764,236

(22) Filed: Feb. 11, 2013

(51) Int. Cl. G06Q 30/06

(52) U.S. Cl. CPC G06Q 30/0639
USPC 705/26.7

(57) ABSTRACT

Customer traffic flow in a retail store is managed to reduce congestion in the aisles. A processor receives individual shopping lists from customer's handheld devices as they enter the store. The processor may augment the lists with cross-sell items and up-sell items based on customer profile data and projected congestion near the cross-sell and up-sell items. The processor computes an optimized path for each customer to minimize congestion and provides the path as a recommendation to each customer via their handheld device.

### BACKGROUND OF THE INVENTION

1. Field of the Invention

The invention relates to operation of a retail store. More specifically, the invention relates to providing a suggested path for customers to take through the store to reduce congestions. Each individual path is based upon all individual shopping lists of a plurality of customers and other inputs.

2. Description of the Related Art

In the prior art, there have been attempts to minimize the path traveled or minimize the time taken for shopping in a store. For example, Hui et. al., in their paper titled, “The Traveling Salesman Goes Shopping,” published Nov. 5, 2006, by the Wharton School of the University of Pennsylvania, describes how the generic traveling salesman problem can be tailored to optimize the path taken by a shopper within a store.

Yaman et al in their paper titled, “Clustering Grocery Shopping Paths of Customers by using Optimization-Based Models,” published by the 20th EURO Mini Conference on Continuous Optimization and Knowledge-Based Technologies, May 20-23, 2008, in Nerings, Lithuania describes how to categorize shoppers based on the path taken by the shopping cart, using video analytics.

### BRIEF SUMMARY OF THE INVENTION

Traffic flow in a retail store is optimized to reduce congestion, thereby improving customer satisfaction and increasing throughput. Prior to or upon entry into a store, some customers enter a shopping list of items they wish to purchase into their portable device. Other customers also enter the store. Each shopping list includes the number of adults and children shopping together.

The lists are transferred to a processor in real time. The processor may append cross-sell and up-sell items to any of the lists based upon the customer's profile, buying opportunities, customer solution offerings, or projected traffic within the store near a particular cross-sell or up-sell item.

The processor determines an optimized suggested path through the store for each customer based on their appended shopping list, all the other shopping lists, current store layout, number of adults and children shopping together for each customer, and estimated location and number of other customers without shopping lists, for each point in time. Each suggested path corresponding to each appended shopping list is sent in real time to each respective portable device where it is presented to the respective customer.

Customers who deviate from their suggested path may be sent updated suggested paths upon demand from the customer or when such deviation is detected by the processor.

### BRIEF DESCRIPTION OF THE SEVERAL VIEWS OF THE DRAWINGS

FIG. 1 is a front view of a portable device for entering a shopping list and receiving a suggested path;

FIG. 2 shows a store layout of items, shelves, and aisles;

FIG. 3 depicts cross-sell and up-sell items appended to a shopping list;

FIG. 4 is a chart showing suggested paths for three customers;

FIG. 5 is a flowchart of steps in practicing the present invention; and

FIG. 6 is a processor for implementing the present invention.

### DETAILED DESCRIPTION OF THE INVENTION

For a better understanding of the present invention, together with other and further objects, advantages, and capabilities thereof, reference is made to the following disclosure and the appended claims in connection with the above-described drawings.

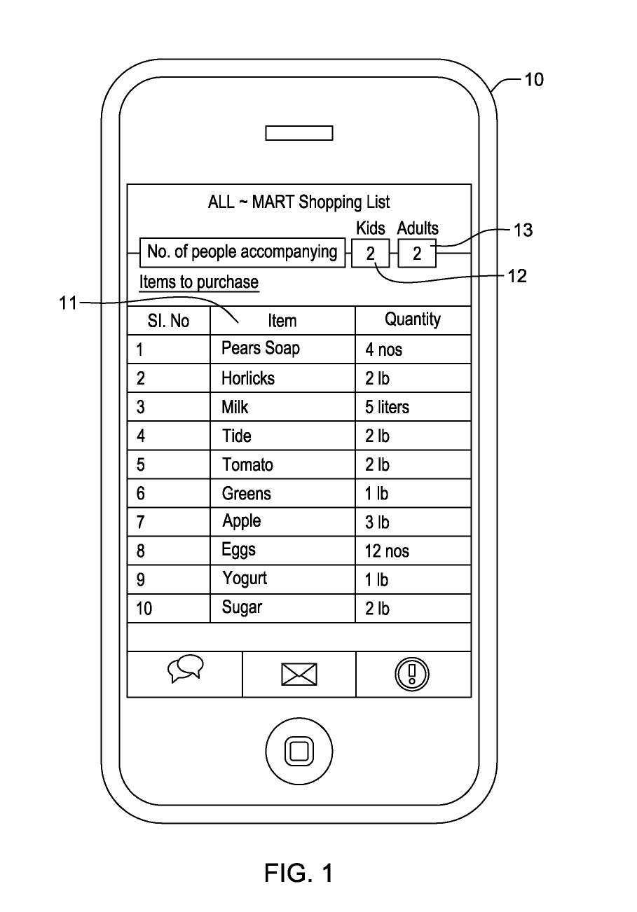

In FIG. 1, there is shown handheld device 10 which may be a smart phone, a palmtop computer, or any other portable device capable of recording entries of items 11 in a shopping list. The shopping list also has number of adults 12 and number of children 13 who will be shopping at a retail store together for items 11. Device 10 is capable of wireless communication with a network having a processor as described below. Device 10 is taken along on a shopping trip to the retail store.

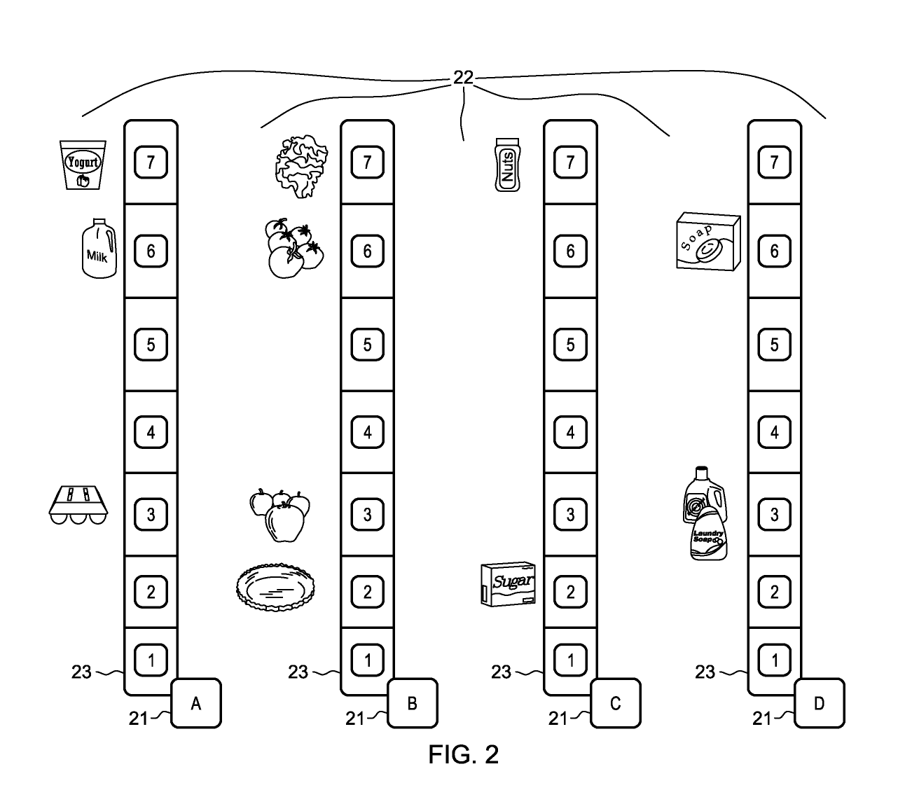

In FIG. 2, there is shown a layout of a retail store. Rows of shelves 23 separated by aisles 22 have various items of merchandise depicted. Although the merchandise shown, such as fruit, eggs, milk, and laundry detergent, are typically found in a grocery store, the invention may be applied in any type of retail store. Customers enter the store and make a path along some or all of aisles 22 before checkout and leaving the store. The customer may use a shopping cart if there are many items on her shopping list.

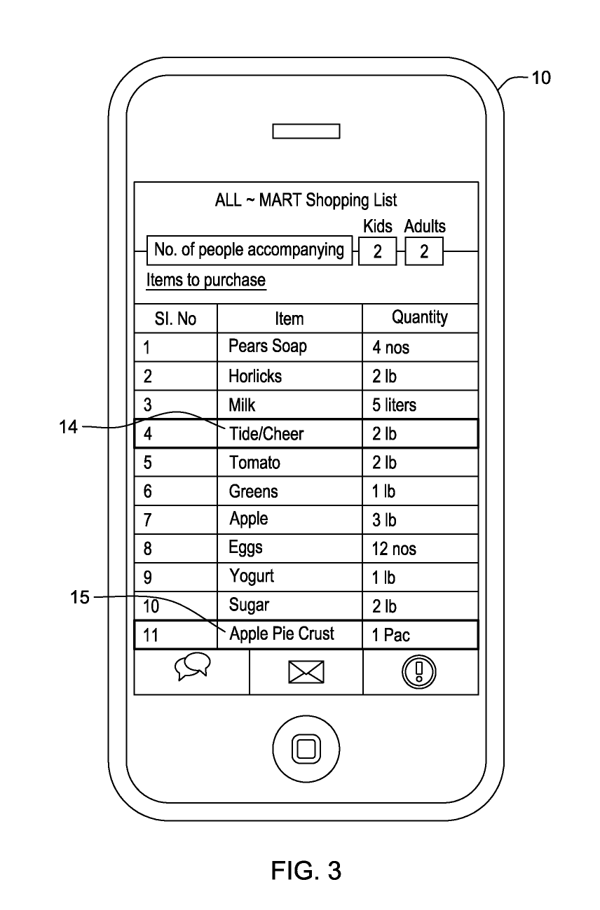

In FIG. 3, there is shown device 10 with additional cross-sell item 15 and up-sell item 14 appended to the shopping list of FIG. 1. Upon entry into the retail store, the shopping list of FIG. 1 is communicated to a processor over a wireless connection. The processor may also be referred to herein as a store greeting system (SGS). The processor selects items not on the list for cross-sell and up-sell opportunities and appends these items as shown in FIG. 3.

Cross-sell shall be taken herein to mean an item is selected because of its relation to one or more items already on the list. For example, apple pie crust may be selected for cross-sell if apples are already on the list.

Up-sell shall be taken herein to mean selecting a higher quality brand item to replace, for example, a lower cost or generic brand of the same item type, i.e. laundry detergent.

The processor selects items for cross-sell and up-sell based upon a large number of considerations. Specifically, the customer profile, which shall be taken herein to mean any data gathered about the customer, such as income level, products previously purchased, her neighborhood residential characteristics, age, gender, and family details, are all considered. Furthermore, the processor also considers buying opportunity indices which shall be taken herein to mean pre-defined or dynamically defined cross-product tendencies of consumers. For example, cake mix and cake frosting or other “pairings”. The processor also considers customer solution offerings which shall be taken herein to mean complimentary products to ones already on the lists. A solution offering shall be taken herein to mean a complete kit or solution comprising products which are often purchased together. For example, a computer solution comprising a laptop, printer, ink cartridge, paper, and warranties. Another example may be a back-to-school solution comprising a backpack, pencils, pencil case, and notebooks.

The processor also considers what the traffic flow will be near the locations of potential cross-sell and up-sell items based on what is on other customers' suggested paths at the point in time this customer is expected to reach the cross-sell and up-sell item locations. The processor also estimates the number and location of other customers who did not present a shopping list when entering the retail store and additionally estimates the location and number of such other customers who will enter the store during the time the particular shopping list customer is present therein. The processor also considers these other customers in computing estimated congestion. Items may therefore be appended or not based upon all of the above considerations with a goal of reducing congestion while also increasing sales with the appended items.

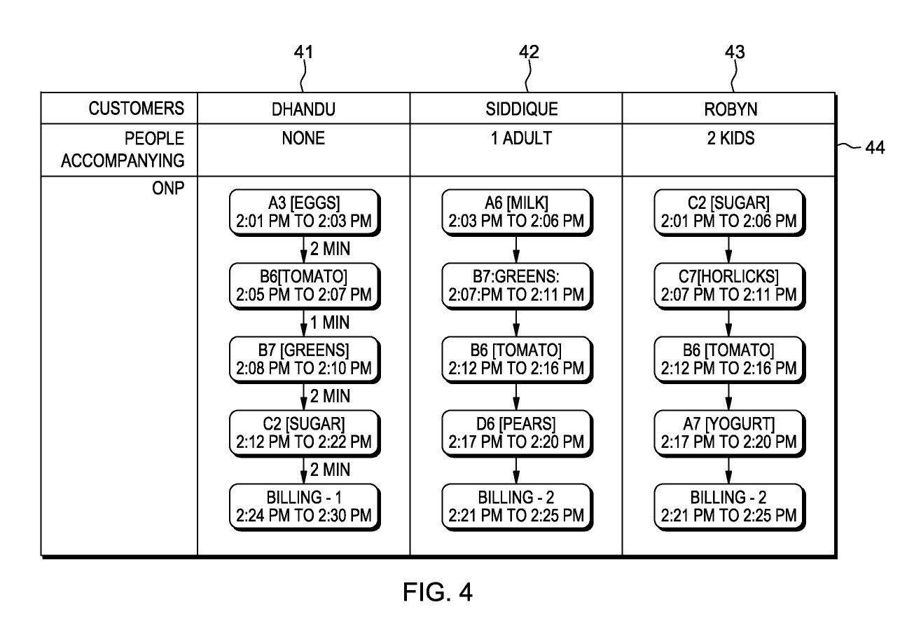

In FIG. 4, there is shown a chart of suggested paths for three customers Dhandu 41, Siddique 42, and Robyn 43. The chart also shows the number of people shopping together (accompanying) in row 44. In operation, such a chart may be used by the processor, but each individual customer will receive only her individual suggested path as sent to her individual handheld device 10.

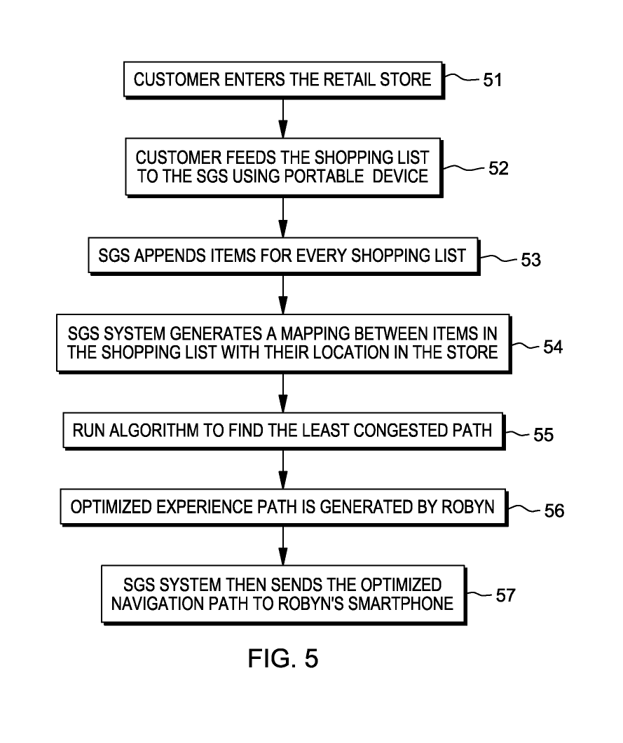

In FIG. 5, there is shown a flowchart of steps performed in one embodiment of the present invention. In step 51, a customer enters the retail store. In step 52, the customer's shopping list on her portable device 10 is fed to the store greeting system (SGS). The SGS appends cross-sell and up-sell items to every shopping list as appropriate in step 53. In some cases, such as upon customer request, or to reduce congestion, no items are appended to a particular list.

In step 54, the SGS generates a mapping between items in a particular list, or appended list, and the item locations in the store.

In step 55, the SGS runs an optimization algorithm to find a least congested path for that customer. The algorithm may include use of day-part analytics. The system leverages all pre-identified parameters surrounding the specific customer in aggregate with other customers being currently considered by the system. Based on the current and dynamic condition of the store relative to other known customer paths and where they are relative to a time-based scale inside of their current path, and an estimation of known or predicted presence of other customers moving around the store, and the assessed and understood objectives of the current customer, the system generates an optimized path through the store based on known and current plan-o-gram and layout. The system also considers current promotions as applicable to the current customer. The system also considers cross-sell and up-sell opportunities as applicable to the current customer. The system considers current customer objectives, aligned with present customers inside of ‘paths’, projected or unknown customers, current store physical experience and condition, current promotions and relevant business objectives, related cross-sell and up-sell products to be able to develop a personalized path for that customer that optimizes their current experience based on known and projected objectives. Any known optimization techniques may be used to generate the optimized path, such as linear programming, nonlinear programming, or exhaustive search.

In step 56, the optimized recommended path is generated for a particular customer, for example, Robyn. The path is then sent in step 57 to Robyn's portable device 10, which may be a smart phone. Path optimization benefits the customer experience as described above but also meets identified business objectives for the retailers, including metrics, such as profitability, shopper trip optimization, resource optimization, and intent to sell.

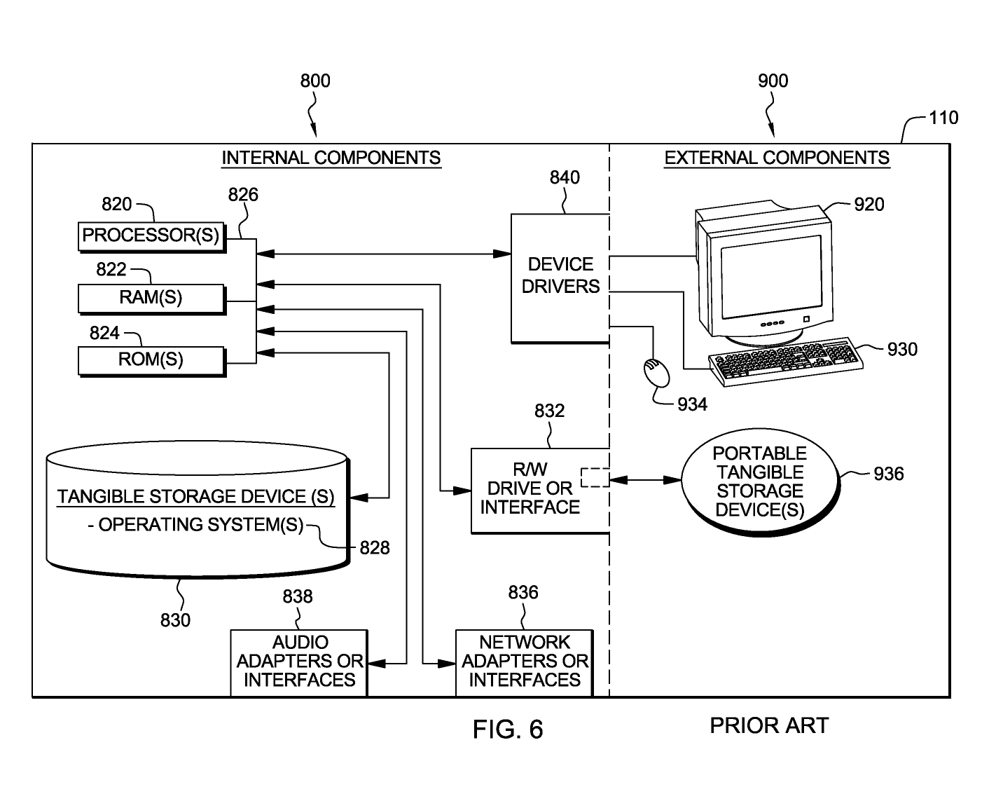

FIG. 6 shows a block diagram of internal components 800 and external components 900 of a computer 110, in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Computer 110 is representative of any electronic device capable of executing machine-readable program instructions. Computer 110 may be representative of a computer system or other electronic devices. Examples of computing systems, environments, and/or configurations that may be represented by computer 110 include, but are not limited to, personal computer systems, server computer systems, thin clients, thick clients, laptop devices, smart phones, multiprocessor systems, microprocessor-based systems, network PCs, minicomputer systems, and distributed cloud computing environments that include any of the above systems or devices.

Computer 110 includes a set of internal components 800 and external components 900. Internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, functions in computer device 110 are stored on one or more of the respective computer-readable tangible storage devices 830 for execution by one or more of the respective processors 820 via one or more of the respective RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. Functions in computer 110 can be stored on one or more of the respective portable computer-readable tangible storage devices 936, read via the respective R/W drive or interface 832 and loaded into the respective hard drive 830.

Internal components 800 also includes audio adapters or interfaces 838 such as a sound card, hardware mixer, amplifier, or other adapters or interfaces for receiving audio signals from microphones.

Internal components 800 also includes network adapters or interfaces 836 such as a TCP/IP adapter cards, wireless wi-fi interface cards, or 3G or 4G wireless interface cards or other wired or wireless communication links. Functions in computer 110 can be downloaded to computer 110 from an external computer via a network (for example, the Internet, Cloud 24, a local area network or other, wide area network) and respective network adapters or interfaces 836. From the network adapters or interfaces 836. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

FIG. 6 may describe in more detail some of the computing resources comprising the store greeting system of FIG. 5.

In some embodiments, a processor, as described in connection with FIG. 6, may be included in handheld device 10 for implementing various functions described above, including the steps of FIG. 5.

FIG. 6 may describe in more detail some of the computing resources comprising the store greeting system of FIG. 5.

The foregoing description of various embodiments of the present invention has been presented for purposes of illustration and description. It is not intended to be exhaustive or to limit the invention to the precise form disclosed. Many modifications and variations are possible. Such modifications and variations that may be apparent to a person skilled in the art of the invention are intended to be included within the scope of the invention as defined by the appended claims.

What is claimed is:

1. A method of managing customer traffic flow in a retail store, comprising the steps of:
receiving shopping lists of items from customers prior to or upon their entry into a retail store;
for each customer who provides a shopping list, offering cross-sell and up-sell items appended to said shopping list; and
providing an optimized suggested path through said retail store to each said customer based upon all of the appended to shopping lists, the number of adults and children visiting said retail store together for each customer, and current store layout of said items.

2. The method of claim 1, wherein first additional customers are present in said store who have not presented a shopping list, and said optimized suggested path is further based on an estimated location and number of said first additional customers at each point in time.

3. The method of claim 2, wherein second additional customers without shopping lists are estimated to enter said retail store during the time one said customer is present in said retail store, and said optimized suggested path is further based on an estimated location and number of said second additional customers at each point in time said one said customer is present in said retail store.

4. The method of claim 1, wherein said offering of cross-sell and up-sell items are based upon customer profile or buying opportunity indices, or customer solution offerings.

5. The method of claim 4, wherein said offering of cross-sell and up-sell items are further based upon number and projected location of said customers at each point in time, and location of said cross-sell and up-sell items in said retail store.

6. A system for managing customer traffic flow in a retail store, comprising:
a retail store having items located on shelves along aisles;
a plurality of portable devices, carried by a plurality of customers in said retail store, each of said devices having a shopping list, including the number of adults and children visiting said retail store together;
a processor in communication with said portable devices, said processor programmed to provide cross-sell items and up-sell items appended to each said shopping list; and
said processor programmed to provide an optimized suggested path through said retail store to each said customer based upon all of the appended to shopping lists, the number of adults and children visiting said retail store together for each customer, and current store layout of said items.

7. The system of claim 6, wherein first additional customers are present in said store who have not presented a shopping list, and said optimized suggested path is further based on an estimated location and number of said first additional customers at each point in time.

8. The system of claim 7, wherein second additional customers without shopping lists are estimated to enter said retail store during the time one said customer is present in said retail store, and said optimized suggested path is further based on an estimated location and number of said second additional customers at each point in time said one said customer is present in said retail store.

9. The system of claim 6, wherein said offering of cross-sell and up-sell items are based upon customer profile or buying opportunity indices, or customer solution offerings.

10. The system of claim 9, wherein said offering of cross-sell and up-sell items are further based upon number and projected location of said customers at each point in time, and location of said cross-sell and up-sell items in said retail store.

11. A computer program product for managing customer traffic flow in a retail store, said computer program product comprising:
a computer readable storage device;
first program instruction means for receiving shopping lists of items from customers prior to or upon their entry into a retail store;
second program instruction means for offering for each customer who provides a shopping list, cross-sell and up-sell items appended to said shopping list; and
third program instruction means for providing an optimized suggested path through said retail store to each said customer based upon all of the appended to shopping lists, the number of adults and children visiting said retail store together for each customer, and current store layout of said items; and wherein all said program instructions means are recorded on said storage device.

12. The computer program product of claim 11, wherein first additional customers are present in said store who have not presented a shopping list, and said optimized suggested path is further based on an estimated location and number of said first additional customers at each point in time.

13. The computer program product of claim 12, wherein second additional customers without shopping lists are estimated to enter said retail store during the time one said customer is present in said retail store, and said optimized suggested path is further based on an estimated location and number of said second additional customers at each point in time said one said customer is present in said retail store.

14. The computer program product of claim 11, wherein said offering of cross-sell and up-sell items are based upon customer profile or buying opportunity indices, or customer solution offerings.

15. The computer program product of claim 14, wherein said offering of cross-sell and up-sell items are further based upon number and projected location of said customers at each point in time, and location of said cross-sell and up-sell items in said retail store.
